(19) United States
(12) Patent Application Publication
(10) Pub. No.: US 2020/0134647 A1
(43) Pub. Date: Apr. 30, 2020

(54) SYSTEM AND METHOD TO COLLECT DATA TO QUANTIFY SENTIMENT OF USERS AND PREDICT OBJECTIVE OUTCOMES

(71) Applicant: RedLotus (Hong Kong) Ltd, Hong Kong (HK)

(72) Inventor: Gurbaksh Chahal, Hong Kong (HK)

(21) Appl. No.: 16/717,845

(22) Filed: Dec. 17, 2019

(51) Int. Cl. G06Q 30/02; G06F 16/9535

(52) U.S. Cl. CPC G06Q 30/0202; G06F 16/9535; G06Q 50/01; G06Q 30/0269; G06Q 30/0254

(57) ABSTRACT

Disclosed is a system and method to collect data from a plurality of data sources to quantify the sentiment of users and predict objective outcomes. The method includes the step of collecting sentiment data from the first data sources associated with the user to determine an opinion of the user pertaining to products, and services through a sentiment analysis module. The method includes the step of collecting action data from the second data sources associated with the user to determine the behavior of the user through a behavioral analysis module. The second data sources include social media platforms, digital shopping platforms, and native applications. The method includes the step of collecting demographic data of the user from the third data sources to determine the profile of the user through a demographic profiling module. The third data source comprising a telecom server. The method includes the step of storing and analyzing data pertaining to the determined opinion of the user, determined behavior of the user, and determined profile of the user and computing a user profile value through a server. The method includes the step of presenting a persistent view of the analyzed data corresponding to the user through a user interface connected to a central computing device that configures the server with the telecom server.

### TECHNICAL FIELD

The present invention relates to capturing and calibrating user's sentiment, in particular to a system and method to collect data from a plurality of data sources to quantify sentiment of one or more users and predict one or more objective outcomes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in-and-of-themselves may also be inventions.

With the advent of digitalization of enterprises and the convergence of physical and digital assets and capabilities, digital technologies have become an integral part of any business process. They have become the core of differentiation and sustenance for any business. The digitalization movement is unearthing an explosion of opportunities for enterprises to apply technology, innovate their business process and deliver value to their customers. The rapid rate of change in digital technology is influencing the rate of change in business models and operations. Due to the growth of online usage surges, the signal to noise ratio continues to widen. Consumers now live in a subjective online world leading to very different offline activities. Behaviors have now become multi-dimensional. This specification recognizes that it is imperative for executives and the key stakeholders of an enterprise to be apprised of such changes in their respective dynamically evolving ecosystems, to stay ahead in their respective businesses.

This specification also recognizes that data may be stored in the various data sources is continuously changing, and it is a challenge to collect the continuously changing data (e.g., in real-time) and present meaningful data upon which meaningful decisions and actions may be taken. Additionally, it is recognized in this specification that the sources of the data may store the data in formats that are not known in advance and may label the data with labels that are not known in advance further complicating the usefulness of automatically quantifying sentiment of the users and making sense of the data so that appropriate predictions of objective outcomes may be captured (e.g., in real-time).

### SUMMARY OF THE INVENTION

The present invention mainly cures and solves the technical problems existing in the prior art. In response to these problems, the present invention provides a system and method to collect data from a plurality of data sources to quantify the sentiment of one or more users and predict one or more objective outcomes.

An aspect of the present disclosure relates to a method for collecting data from a plurality of data sources to quantify the sentiment of one or more users and predict one or more objective outcomes. The method includes the step of collecting sentiment data from the first data sources associated with the user to determine an opinion of the user pertaining to at least one of one or more products, and one or more services through a sentiment analysis module. The first data sources comprising a plurality of websites. The method includes the step of collecting action data from the second data sources associated with the user to determine the behavior of the user through a behavioral analysis module. The second data sources include but not limited to one or more social media platforms such as Facebook®, one or more digital shopping platforms, and one or more native applications. The method includes the step of collecting demographic data of the user from the third data sources to determine the profile of the user through a demographic profiling module. The third data sources comprising a telecom server. The method includes the step of storing and analyzing data pertaining to the determined opinion of the user, determined behavior of the user, and determined profile of the user and computing a user profile value through a server. The method includes the step of presenting a persistent view of the analyzed data corresponding to the user through a user interface connected to a central computing device that configures the server with the telecom server.

In an aspect, the telecom server appends an identification number such as a Mobile Station International Subscriber Directory Number (MSISDN) corresponding to a computing device of the user to at least one of a user-agent request header, a URL parameter, and one or more HyperText Transfer Protocol (HTTP) protocol requests for a plurality of outgoing traffic.

In an aspect, the telecom server comprising a user profiling data server.

In an aspect, the central computing device reads the identification number from an advertisement request received from the user-agent request header and transmits the reading value to the server.

In an aspect, the server establishes a communication with the user profiling data server to retrieve one or more advertisement campaigns based on the user profile value and predicts the objective outcome indicative to the advertisements relevant to the users.

In an aspect, the action data of the user is indicative to at least one of one or more locations data of the user, one or more purchases data of the user, and one or more expense data of the user.

In an aspect, the profile of the user indicative to at least one of the marital status data of the user, the income data of the user, the birth data of the user, and an ethnicity data of the user.

An aspect of the present disclosure relates to a system to collect data from a plurality of data sources to quantify the sentiment of one or more users and predict one or more objective outcomes. The system includes a processor, a memory communicatively coupled to the processor, a server, and a central computing device. The memory is communicatively coupled to the processor, wherein the memory stores instructions executed by the processor. The memory includes a sentiment analysis module, a behavioral analysis module, and a demographic profiling module. The sentiment analysis module collects sentiment data from the first data sources associated with the user to determine an opinion of the user pertaining to at least one of one or more products and one or more services. The first data sources comprising a plurality of websites. The behavioral analysis module collects action data from the second data sources associated with the user to determine the behavior of the user. The second data sources include one or more social media platforms, one or more digital shopping platforms, and one or more native applications. The demographic profiling module collects demographic data of the user from the third data sources to determine the profile of the user. The third data source comprising a telecom server. The server stores and analyzes data pertaining to the determined opinion of the user, determined the behavior of the user, and determined the profile of the user and computes a user profile value. The central computing device configures the server with the telecom server and presents a persistent view of the analyzed data corresponding to the user through a user interface.

Accordingly, one advantage of the present invention is that it defines, detects, extracts, categorizes, connects, analyzes and visualizes data from the various online and offline sources to quantify sentiment of the users and predict objective outcomes.

Accordingly, one advantage of the present invention is that it automates the quantification of the user's sentiment to predict objective outcomes.

Accordingly, one advantage of the present invention is that it provides telecom partners/operators with new data monetization and revenue opportunities.

Accordingly, one advantage of the present invention is that it provides a secure environment for the profiles of the users because the profiles of the users are stored in the telecom server of the telecom partners.

Other features of embodiments of the present disclosure will be apparent from accompanying drawings and from the detailed description that follows.

Yet other objects and advantages of the present invention will become readily apparent to those skilled in the art following the detailed description, wherein the preferred embodiments of the invention are shown and described, simply by way of illustration of the best mode contemplated herein for carrying out the invention. As we realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a network implementation of the present system to collect data from a plurality of data sources to quantify sentiment of one or more users and predict one or more objective outcomes, in accordance with at least one embodiment.

FIG. 2 illustrates a block diagram of the various modules within a memory of a data collection and sentiment quantification device for collecting data from a plurality of data sources for quantifying sentiment of one or more users and predict one or more objective outcomes, in accordance with at least one embodiment.

FIG. 3 illustrates an architecture of the present system for collecting data from a plurality of data sources for quantifying sentiment of one or more users and predict one or more objective outcomes, in accordance with at least one embodiment.

FIG. 4 illustrates an operational block diagram of the sentiment analysis module, in accordance with at least one embodiment.

FIG. 5 illustrates an operational block diagram of the behavioral analysis module, in accordance with at least one embodiment.

FIG. 6 illustrates an operational block diagram of the demographic profiling module, in accordance with at least one embodiment.

FIG. 7 illustrates a flowchart of the method to collect data from a plurality of data sources to quantify sentiment of one or more users and predict one or more objective outcomes, in accordance with at least one embodiment.

### DETAILED DESCRIPTION OF THE ILLUSTRATIVE EMBODIMENTS

The present disclosure is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

Systems and methods are disclosed for collecting data from data sources to quantify the sentiment of one or more users and predict one or more objective outcomes. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

Although the present disclosure has been described with the purpose for collecting data from a plurality of data sources to quantify sentiment of one or more users and predict one or more objective outcomes, it should be appreciated that the same has been done merely to illustrate the invention in an exemplary manner and to highlight any other purpose or function for which explained structures or configurations could be used and is covered within the scope of the present disclosure.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or versatile digital disk (DVD), flash memory, memory or memory devices.

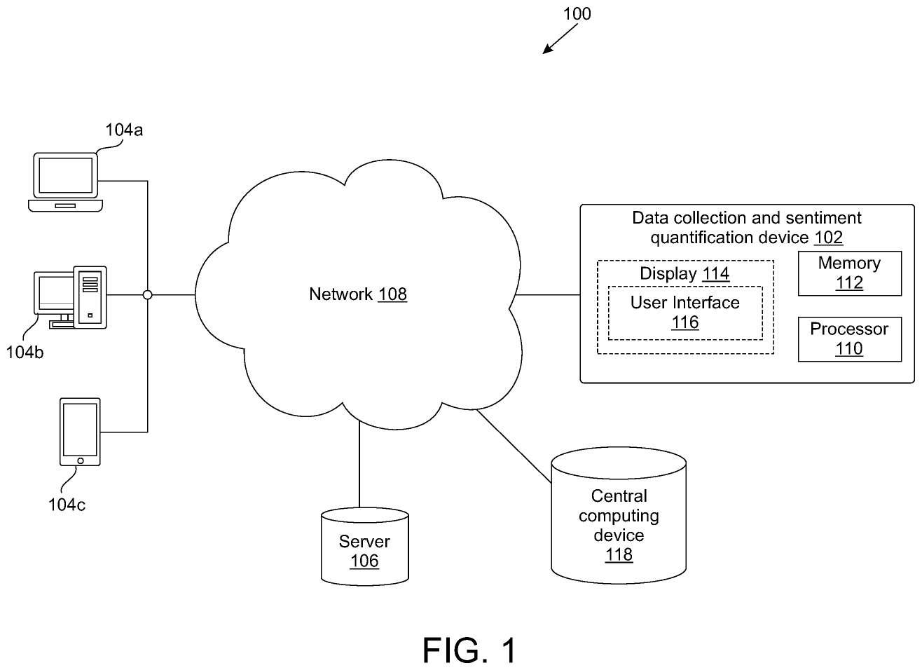

FIG. 1 illustrates a network implementation of the present system 100 to collect data from a plurality of data sources to quantify sentiment of one or more users and predict one or more objective outcomes, in accordance with at least one embodiment. Examples of the objective outcomes include but are not limited to first/third party micro services, real-time customer messaging, data monetization, polling/market research for offline behavior profiling, predictive business intelligence (BI), insights, hidden signals (who they are and where they are going), predictive artificial intelligence-powered customer life-time value (LTV) models, customer sentiment, predictive customer lookalike etc.

System 100 includes a data collection and sentiment quantification device 102 that collect data from a plurality of data sources to quantify the sentiment of one or more users and predict one or more objective outcomes. In particular, data collection and sentiment quantification device 102 collects sentiment data from the first data sources associated with the user to determine an opinion of the user pertaining to at least one of one or more products, and one or more services through a sentiment analysis module. The first data sources comprising a plurality of websites. The data collection and sentiment quantification device 102 collects action data from the second data sources associated with the user to determine the behavior of the user through a behavioral analysis module. The second data sources comprising one or more social media platforms, one or more digital shopping platforms, and one or more native applications.

The data collection and sentiment quantification device 102 collects demographic data of the user from the third data sources to determine the profile of the user through a demographic profiling module. The third data sources comprising a telecom server. In an embodiment, the telecom server is associated with a telecom partner. The method includes the step of storing and analyzing data pertaining to the determined opinion of the user, determined behavior of the user, and determined profile of the user and computing a user profile value through a server. The method includes the step of presenting a persistent view of the analyzed data corresponding to the user through a user interface connected to a central computing device 118 that configures the server with the telecom server. Examples of the central computing device 118 include but not limited to a computer, an advertisement server, a cloud device, a laptop, etc.

The quantified sentiment and predicted objective outcomes may be presented to the user by a plurality of computing devices 104 (for example, a laptop 104a, a desktop 104b, and a smartphone 104c). The quantified sentiment and predicted objective outcomes may be stored within a plurality of computing devices 104. Other examples of a plurality of computing devices 104, may include but are not limited to a phablet and a tablet. Alternatively, the quantified sentiment and predicted objective outcomes may be stored on a server 106 and may be accessed by a plurality of computing devices 104 via a network 108. Network 108 may be a wired or a wireless network, and the examples may include but are not limited to the Internet, Wireless Local Area Network (WLAN), Wi-Fi, Long Term Evolution (LTE), Worldwide Interoperability for Microwave Access (WiMAX), and General Packet Radio Service (GPRS).

When a user of laptop 104a, for example, wants to visualize quantified sentiment and predicted objective outcomes, laptop 104a communicates the same with data collection and sentiment quantification device 102, via network 108. The data collection and sentiment quantification device 102 then presents quantified sentiment and predicted objective outcomes as per the user's request. To this end, data collection and sentiment quantification device 102 includes a processor 110 that is communicatively coupled to a memory 112, which may be a non-volatile memory or a volatile memory. Examples of non-volatile memory may include, but are not limited to flash memory, a Read Only Memory (ROM), a Programmable ROM (PROM), Erasable PROM (EPROM), and Electrically EPROM (EEPROM) memory. Examples of volatile memory may include but are not limited Dynamic Random Access Memory (DRAM), and Static Random-Access memory (SRAM).

Processor 110 may include at least one data processor for executing program components for executing user- or system-generated requests. A user may include a person, a person using a device such as those included in this disclosure, or such a device itself. Processor 110 may include specialized processing units such as integrated system (bus) controllers, memory management control units, floating-point units, graphics processing units, digital signal processing units, etc.

Processor 110 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 110 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 110 may be disposed of in communication with one or more input/output (I/O) devices via an I/O interface. I/O interface may employ communication protocols/methods such as, without limitation, audio, analog, digital, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

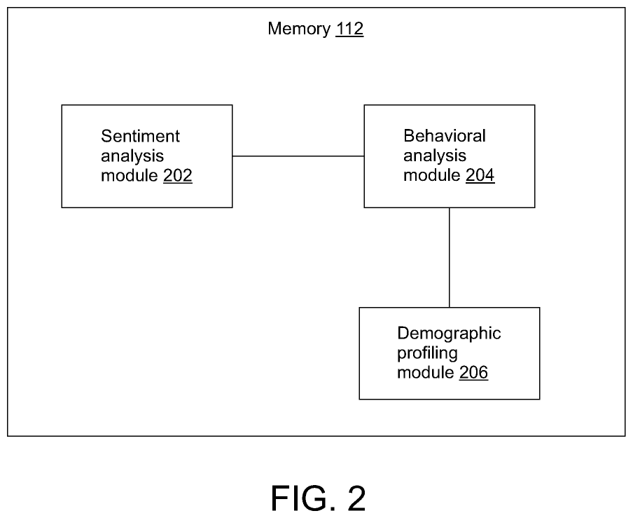

Memory 112 further includes various modules that enable data collection and sentiment quantification device 102 to collect quantified sentiment and presents predicted objective outcomes as requested by the user. These modules are explained in detail in conjunction with FIG. 2. Data collection and sentiment quantification device 102 may further include a display 114 having a User Interface (UI) 116 that may be used by a user or an administrator to initiate a request to view quantified sentiment and predicted one or more objective outcomes to data collection and sentiment quantification device 102. Display 114 may further be used to display quantified sentiment and predicted objective outcomes. The functionality of data collection and sentiment quantification device 102 may alternatively be configured within each of plurality of computing devices 104.

FIG. 2 illustrates a block diagram of the various modules within a memory 112 of a data collection and sentiment quantification device for collecting data from a plurality of data sources for quantifying sentiment of one or more users and predict one or more objective outcomes, in accordance with at least one embodiment. Memory 112 includes a sentiment analysis module 202, a behavioral analysis module 204 and a demographic profiling module 206.

In one implementation, the sentiment analysis module 202 collects sentiment data from the first data sources associated with the user to determine an opinion of the user pertaining to at least one of one or more products and one or more services. The first data sources comprising a plurality of websites. The behavioral analysis module 204 collects action data from the second data sources associated with the user to determine the behavior of the user. In an embodiment, the action data of the user is indicative to at least one of one or more locations data of the user, one or more purchases data of the user, and one or more expense data of the user.

The second data sources include one or more social media platforms, one or more digital shopping platforms, and one or more native applications. The demographic profiling module 206 collects demographic data of the user from the third data sources to determine the profile of the user. In an embodiment, the profile of the user indicative to at least one of the marital status data of the user, the income data of the user, the birth data of the user, and an ethnicity data of the user.

The third data sources comprising a telecom server. In an embodiment, the telecom server appends an identification number (MSISDN) corresponding to a computing device of the user to at least one of a user-agent request header, a URL parameter, and one or more HyperText Transfer Protocol (HTTP) protocol requests for a plurality of outgoing traffic. In an embodiment, the telecom server comprising a user profiling data server. Examples of the identification number (MSISDN) include but are not limited to a service set identifier (SSID) number, media access control address (MAC address), International Mobile Equipment Identity (IMEI), IMSI, Mobile Station International Subscriber Directory Number (MSISDN), etc.

The server stores and analyzes data pertaining to the determined opinion of the user, determined the behavior of the user, and determined the profile of the user and computes a user profile value. In an embodiment, the server establishes a communication with the user profiling data server to retrieve one or more advertisement campaigns based on the user profile value and predicts the objective outcome indicative to the advertisements relevant to the users. The user profiling data server stores a plurality of user profile attributes. The following Table 1 lists key user profile attributes in order of priority. The more the present system supports high priority ones, the better is the eventual advertisement targeting.

TABLE 1

| Attribute | Description |
|---|---|
| Real-time balance | To advertise appropriately priced products |
| | (Incl. prepaid/post-paid if possible) |
| City | Dubai, Abu Dhabi, Mumbai, London etc. |
| Age | DOB or Age or age-group range is also |
| | accepted |
| Gender | Male \|Female |
| ARPU | Helps gauge the buying power of the user |
| Home Location | Home location area |
| Office Location | Office location area |
| National/International | E.g., Roaming with UAE (specific emirate); |
| Roamer | Roaming outside UAE (India, UK, USA, etc.) |
| Nationality | INDIA, UAE, UK, USA, etc. |
| Hyper Location | Cell site address based location e.g., |
| | Al Salam Tower |
| Connection Speed | 2G/3G/4G |
| User preferred language | E.g., English, Hindi, Marathi, Arabic, |
| | Urdu, etc. |
| Office Location | Age of the device e.g., Blackberry Z10 |
| | active for <1 month, 1-6 months, 6-12 |
| | months |
| National/International | Data Usage: <5 MB (WAP/text based app |
| Roamer | user), 5 MB-50 MB (+mail user), 50-200 |
| | MB (+SN user), >200 MB(+Video user) |
| Nationality | User is consuming on Mobile Web e.g., |
| | Sites visited more often/spent time more |
| | often |
| Hyper Location | Content consumption pattern e.g., User is |
| | subscribed/using Cricket, News, Movies, etc. |
| Connection Speed | SMS meter: <5, 5-50 SMS, 50-200 SMS, >200 |
| | SMS |
| User preferred language | Most visited sites, etc. |

The central computing device 118 configures the server with the telecom server and presents a persistent view of the analyzed data corresponding to the user through a user interface. In an embodiment, the central computing device 118 reads the identification number (MSISDN) from an advertisement request received from the user-agent request header and transmits the reading value to the server.

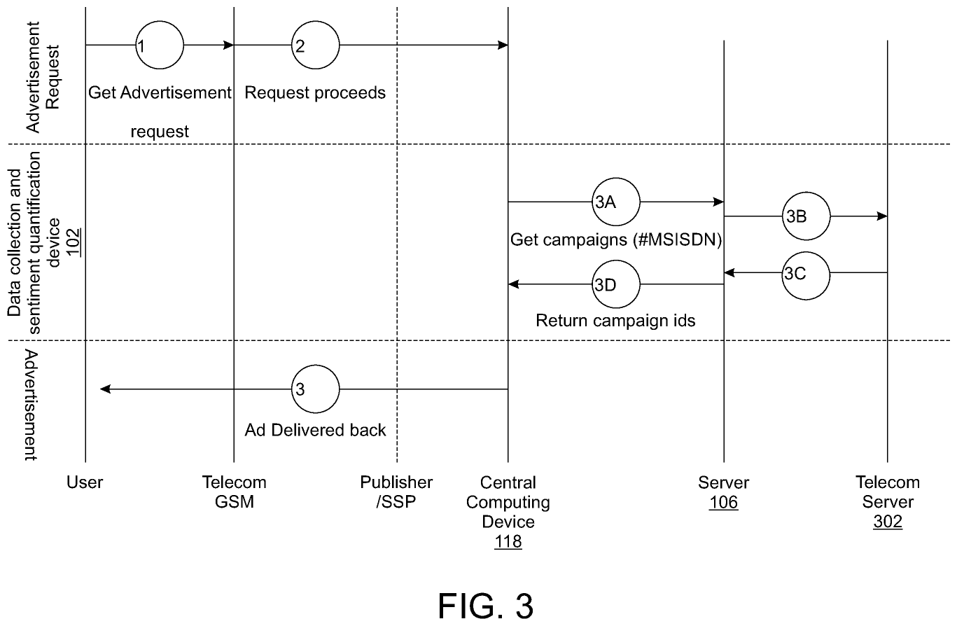

FIG. 3 illustrates an architecture 300 of the present system for collecting data from a plurality of data sources for quantifying sentiment of one or more users and predict one or more objective outcomes, in accordance with at least one embodiment. The architecture 300 is integrated within the data collection and sentiment quantification device 102 to provide a secured API integration between various entities. The architecture 300 depicts how information flow between various entities. An advertisement request arrives (1) from a client or an organization. In an embodiment, a Gateway GPRS Support Node (GGSN) which is a main component of the GPRS network appends identification number such as MSISDN to the user agent header. The advertisement request transmitted (2) to the central computing device 118 which acts as an advertisement server. The advertisement request proceeds to the central computing device 118, either directly or indirectly via a publisher or supply-side platform (SSP) or sell-side platform SSP. The central computing device 118 passes (3A) identification number (MSISDN) to the server 106 hosted with the telecom server 302 of the telecom partner/operator. The server 106 contacts (3B) telecom's user profiling data server to get (3C) profile information of the user. Based on the user profile, the server 106 filters (3D) relevant campaign identification details. The server 106 selects the campaign details and transmits to the central computing device 118. The relevant advertisement is transmitted (3) to the user.

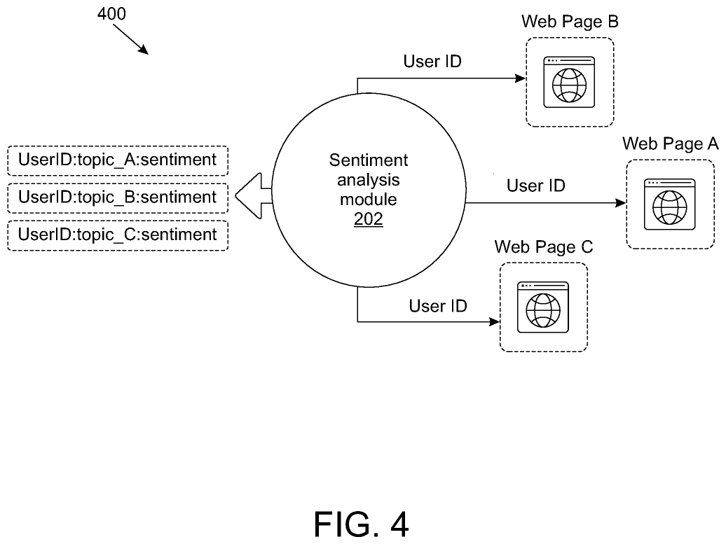

FIG. 4 illustrates an operational block diagram 400 of the sentiment analysis module 202, in accordance with at least one embodiment. The sentiment analysis module 202 determines the sentiment of the users (e.g. view and beliefs that they hold). The sentiment analysis module 202 utilizes various machine learning algorithms and a lexicon-based approach to analyze the data obtained from various online sources and offline sources. The sentiment analysis module 202 categorizes the sentiment of the users corresponding to their profile. In an embodiment, the sentiment analysis module 202 computes the sentiment of the users by performing a plurality of steps. In one of the steps, the sentiment analysis module 202 uses a point-based intent analysis classifier to ‘weight’ the words retrieved from the user's digital behavior on different web pages. For example, the sentiment of the user towards the brand (for purchase, intent, etc.) is ‘weighted’ on point system basis such as −1 (Negative), 1.0 (Positive), and 0.5 (Neutral).

In another step, when data comes from any offline data control group, a statistical data model is applied to make an inference on which group to target and who to exclude target from the core behavior group. Further, the sentiment analysis module 202 may create a training model to pre-process the received online/offline content. The content is scraped from any and all originating sources through natural language processing (NLP) by using keyword analysis, image classifier for sentiment, domain origin/signal analysis, psychographic analysis on key emotions (happy, sad, content, hurt, anger, fear etc.), weather analysis with real-time location (hot, cold, fall, extreme winter, extreme hot etc.), economic demographic/HHI: Neighborhood Demo, historic behavior (if any applicable attributes), and core sentiment model (negative, positive, neutral). In one of the steps, sentiment analysis module 202 may perform logistic regression analysis by event trigger that includes conversion, response, engagement, and desired outcome.

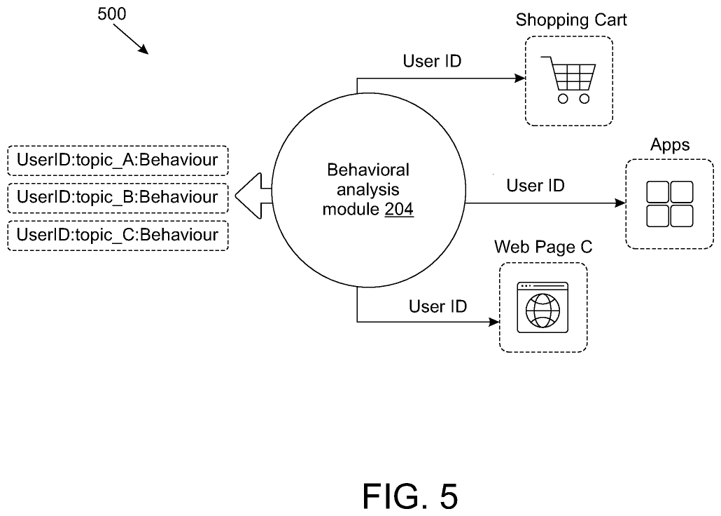

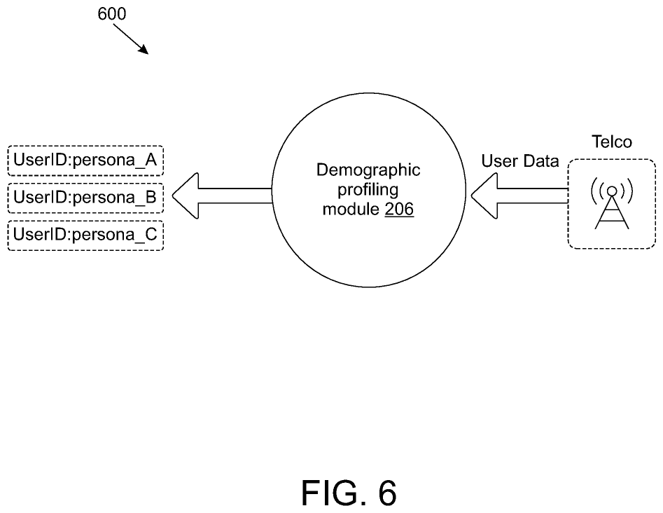

FIG. 5 illustrates an operational block diagram 500 of the behavioral analysis module 204, in accordance with at least one embodiment. The behavioral analysis module 204 performs behavioral analysis of the user by gathering a profile based on the actions of the users (e.g., where were they, what did they buy, where do they spend their time, etc.) These actions can be collected through a kiosk of a retail store, interactions with various mobile applications, and digital behavior or digital interactions. Then this data is used to categorize the users based on their online/offline behavior. FIG. 6 illustrates an operational block diagram 600 of the demographic profiling module 206, in accordance with at least one embodiment. The demographic profiling module 206 collects the demographic data of the users (such as marital status, date of birth, income level, etc.). The demographic data can be captured from the telecom operators. The data collected from the sentiment analysis module 202, the behavioral analysis module 204, and the demographic profiling module 206 is combined into the server (shown in FIG. 1) to provide a persistent view of a user. The present system captures these data and unified each attribute of the user into a singular viewpoint by using various AI/ML techniques.

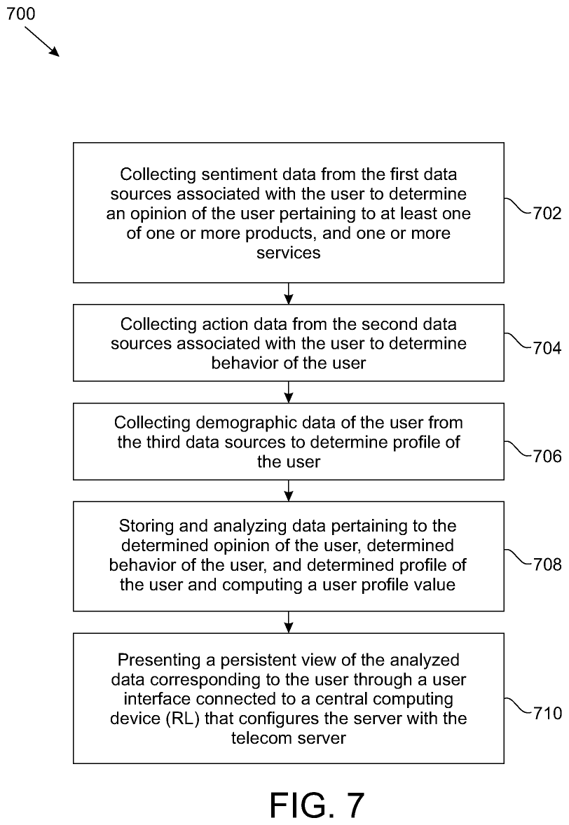

FIG. 7 illustrates a flowchart 700 of the present method to collect data from a plurality of data sources to quantify sentiment of one or more users and predict one or more objective outcomes, in accordance with at least one embodiment. The method includes the step 702 of collecting sentiment data from the first data sources associated with the user to determine an opinion of the user pertaining to at least one of one or more products, and one or more services through a sentiment analysis module. The first data sources comprising a plurality of websites. The method includes the step 704 of collecting action data from the second data sources associated with the user to determine the behavior of the user through a behavioral analysis module. The second data sources comprising one or more social media platforms, one or more digital shopping platforms, and one or more native applications. In an embodiment, the action data of the user is indicative to at least one of one or more locations data of the user, one or more purchases data of the user, and one or more expenses data of the user.

The method includes the step 706 of collecting demographic data of the user from the third data sources to determine the profile of the user through a demographic profiling module. In an embodiment, the profile of the user indicative to at least one of a marital status data of the user, an income data of the user, a birth data of the user, and an ethnicity data of the user. The third data sources comprising a telecom server. In an embodiment, the telecom server appends an identification number (MSISDN) corresponding to a computing device of the user to at least one of a user-agent request header, a URL parameter, and one or more HyperText Transfer Protocol (HTTP) protocol requests for a plurality of outgoing traffic. In an embodiment, the telecom server comprising a user profiling data server.

The method includes the step 708 of storing and analyzing data pertaining to the determined opinion of the user, determined behavior of the user, and determined profile of the user and computing a user profile value through a server. In an embodiment, the server establishes a communication with the user profiling data server to retrieve one or more advertisement campaigns based on the user profile value and predicts the objective outcome indicative to the advertisements relevant to the users.

The method includes the step 710 of presenting a persistent view of the analyzed data corresponding to the user through a user interface connected to a central computing device 118 that configures the server with the telecom server. In an embodiment, the central computing device 118 reads the identification number (MSISDN) from an advertisement request received from the user-agent request header and transmits the reading value to the server.

Thus, the present system, device, and method provide an efficient, simpler and more elegant framework that automates the quantification of the user's sentiment to predict objective outcomes. The present system further provides the telecom partners with new data monetization and revenue opportunities. Further, the present system and method provide a secure environment for the profiles of the users because the profiles of the users are stored in the telecom server of the telecom partners. Furthermore, the present system bridges the gap between the advertisers and the telecom operators in order to plan the promotional campaigns, offers, etc. to get a better return on investments (RoI).

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

What is claimed is:

1. A system to collect data from a plurality of data sources to quantify sentiment of one or more users and predict one or more objective outcomes, the system comprising:
a processor;
a memory communicatively coupled to the processor, wherein the memory stores instructions executed by the processor, wherein the memory comprising:
a sentiment analysis module to collect sentiment data from the first data sources associated with the user to determine an opinion of the user pertaining to at least one of one or more products, and one or more services, wherein the first data sources comprising a plurality of websites;
a behavioral analysis module to collect action data from the second data sources associated with the user to determine behavior of the user, wherein the second data sources comprising one or more social media platforms, one or more digital shopping platforms, and one or more native applications; and
a demographic profiling module to collect demographic data of the user from the third data sources to determine profile of the user, wherein the third data sources comprising a telecom server; and
a server to store and analyze data pertaining to the determined opinion of the user, determined behavior of the user, and determined profile of the user and computes a user profile value; and
a central computing device to configure the server with the telecom server and presents a persistent view of the analyzed data corresponding to the user through a user interface.

2. The system according to claim 1, wherein the telecom server appends an identification number corresponding to a computing device of the user to at least one of a user-agent request header, a uniform resource locator (URL) parameter, and one or more HyperText Transfer Protocol (HTTP) protocol requests for a plurality of outgoing traffic, wherein the identification number comprises a Mobile Station International Subscriber Directory Number (MSISDN).

3. The system according to claim 1, wherein the telecom server comprising a user profiling data server.

4. The system according to claim 1, wherein the central computing device reads the identification number from an advertisement request received from the user-agent request header and transmits the reading value to the server.

5. The system according to claim 1, wherein the server establishes a communication with the user profiling data server to retrieve one or more advertisement campaigns based on the user profile value and predicts the objective outcome indicative to the advertisements relevant to the users.

6. The system according to claim 1, wherein the action data of the user is indicative to at least one of one or more locations data of the user, one or more purchases data of the user, and one or more expenses data of the user.

7. The system according to claim 1, wherein the profile of the user indicative to at least one of a marital status data of the user, an income data of the user, a birth data of the user, and an ethnicity data of the user.

8. A method to collect data from a plurality of data sources to quantify sentiment of one or more users and predict one or more objective outcomes, the method comprises steps of:
collecting, by a data collection and sentiment quantification device, sentiment data from the first data sources associated with the user to determine an opinion of the user pertaining to at least one of one or more products, and one or more services through a sentiment analysis module, wherein the first data sources comprising a plurality of web sites;
collecting, by the data collection and sentiment quantification device, action data from the second data sources associated with the user to determine behavior of the user through a behavioral analysis module, wherein the second data sources comprising one or more social media platforms, one or more digital shopping platforms, and one or more native applications;
collecting, by the data collection and sentiment quantification device, demographic data of the user from the third data sources to determine profile of the user through a demographic profiling module, wherein the third data sources comprising a telecom server;
storing and analyzing data, by the data collection and sentiment quantification device, pertaining to the determined opinion of the user, determined behavior of the user, and determined profile of the user and computing a user profile value through a server; and
presenting, by the data collection and sentiment quantification device, a persistent view of the analyzed data corresponding to the user through a user interface connected to a central computing device that configures the server with the telecom server.

9. The method according to claim 8, wherein the telecom server appends an identification number corresponding to a computing device of the user to at least one of a user-agent request header, a uniform resource locator (URL) parameter, and one or more HyperText Transfer Protocol (HTTP) protocol requests for a plurality of outgoing traffic, wherein the identification number comprises a Mobile Station International Subscriber Directory Number (MSISDN).

10. The method according to claim 8, wherein the telecom server comprising a user profiling data server.

11. The method according to claim 8, wherein the central computing device reads the identification number from an advertisement request received from the user-agent request header and transmits the reading value to the server.

12. The method according to claim 8, wherein the server establishes a communication with the user profiling data server to retrieve one or more advertisement campaigns based on the user profile value and predicts the objective outcome indicative to the advertisements relevant to the users.

13. The method according to claim 8, wherein the action data of the user is indicative to at least one of one or more locations data of the user, one or more purchases data of the user, and one or more expense data of the user.

14. The method according to claim 8, wherein the profile of the user indicative to at least one of a marital status data of the user, an income data of the user, a birth data of the user, and an ethnicity data of the user.
